(19) United States
(12) Patent Application Publication
(10) Pub. No.: US 2009/0230808 A1
(43) Pub. Date: Sep. 17, 2009

(54) MOTOR STATOR AND MOTOR STATOR MANUFACTURING METHOD

(76) Inventor: Katsuhiko Tatebe, Aichi (JP)

Correspondence Address: KENYON & KENYON LLP, 1500 K STREET N.W., SUITE 700, WASHINGTON, DC, 20005, US

(21) Appl. No.: 12/306,760

(22) PCT Filed: Oct. 19, 2007
(86) PCT No.: PCT/JP2007/070870

§ 371 Date: Dec. 29, 2008

(30) Foreign Application Priority Data
Nov. 24, 2006 (JP) 2006-317201

(51) Int. Cl. H02K 3/12; H02K 15/085

(52) U.S. Cl. 310/201; 29/596

(57) ABSTRACT

A stator for motor comprises a stator core formed with a plurality of slots in an inner periphery thereof, a plurality of first laminated conductors each including a plurality of laminated thin plates in each slot, a plurality of second laminated conductors each including a plurality of laminated thin plates inserted in each slot, and an end connecting conductor including a plurality of connecting thin plates each having a connecting portion for connecting an end portion of each laminated thin plate of the first laminated conductor in one slot and an end portion of each laminated thin plate of the second laminated conductor in another slot. The thin plates and the connecting portion of each connecting plate are tapered in thickness.

### TECHNICAL FIELD

The present invention relates to a structure of a stator used in a motor and more particularly to a motor stator structure which uses laminated conductors.

### BACKGROUND ART

Heretofore, mainstream stators for use in motors have been winding type stators in which enamel-coated copper wires are inserted into slots in an inner periphery of a stator core and an enamel-coated copper wire is wound around a teeth portion formed between slots. Recently, a stator using laminated conductors for the purposes of stator compactness and high power output as described in JP2001-178053A has also been proposed.

The stator using laminated conductors is more advantageous in two points than the winding type stator. The first advantage is that by adopting a method whereby laminated conductors inserted in slots are joined using an end connecting conductor formed of a laminate of thin plates, the thickness of coil end portions which would expand in the case of the winding type can be reduced, thereby contributing to stator size reduction.

The second advantage is as follows: in connection with higher motor power output, the winding type stator, in which an enamel-coated copper wire is wound around the teeth portion of the stator, must provide the minimum bending radius to prevent the enamel coating from cracking and thus has a limitation that the thickness of the winding itself cannot be larger than a given level. In contrast, the laminate type stator is so constructed as to use a connecting conductor as a separate member to connect the end portions, which means that the cross-section area of the inside of a slot can be larger and the space factor of conductors in the slot can be increased to increase the current density.

FIG. 21 is an exploded perspective view of a motor in JP2001-178053A disclosed as an example of the laminate type stator.

The motor of JP2001-178053A is constituted by combining a stator core 110 with laminated coil pieces 120, an annular first connecting coil piece 130, a second connecting coil piece 140 and a connecting ring 150. Each laminated coil piece 120 is formed by integrally molding two sets of linear laminated thin plate conductors with an insulating resin. The first connecting coil piece 130 and the second connecting coil piece 140 are formed by integrally molding a laminated thin plate conductor with an insulating resin. The connecting ring 150 is formed by combining connecting wires for U, V and W phases and a neutral wire and arranging them in an annular pattern and integrally molding them with an insulating resin.

Then, a machined end portion of one laminated coil piece 120 which is inserted into a slot 114 of the stator core 110, and an end portion of another laminate coil piece 120 inserted into another slot 114 are brought face-to-face with machined end portions of thin plates constituting the first connecting coil piece 130 and the second connecting coil piece 140 and joined by welding and electrically connected.

Since the laminate type stator is thus constructed by combining laminated conductors by resin molding and electrically connecting them by welding, the end portions of the stator are equivalent in size to the thicknesses of the first connecting coil piece 130, the second connecting coil piece 140 and the connecting ring 150, offering an advantage in making the stator compact. Also, each laminated coil piece 120 to be inserted into each slot 114 is made by laminating thin plates and thus the space factor of the slot 114 can be increased to increase the current density, offering an advantage in increasing the stator power output.

However, in manufacturing the motor stator as disclosed in JP2001-178053A, there should be as many as 400 joints between thin plates. Therefore, when joints between thin plates are welded as described in JP2001-178053A, even if a welding technique such as TIG welding or laser welding is employed, the position of a TIG welding torch or laser welding spot must be accurately adjusted to all joints, resulting in a long welding time and higher cost.

In addition, the heat generated during welding might burn the enamel covering the thin plates. Besides, since thin plate end portions are machined, machining cost is required; and also for welding, the laminated coil piece 120, first connecting coil piece 130 and second connecting coil piece 140 have to be positioned with high accuracy.

To solve the problems which might be caused in JP2001-178053A, the present applicant has proposed a stator manufacturing method and a motor stator manufactured by the method in JP2005-137174A. This method uses a conductive adhesive agent to connect thin plates. More specifically, after thin plates are press molded, an end portion of at least one thin plate is coated with conductive adhesive and, after assembling, pressure is applied to join plates. According to this method, the time required for connection can be reduced.

### DISCLOSURE OF THE INVENTION

### Problems to be Solved by the Invention

However, the prior art JP2005-137174A has a problem about the assemblability of end portions. More specifically, when the connecting surface of one thin plate end portion is coated with conductive adhesive as suggested in JP2005-137174A, if an edge of the other thin plate scrapes the surface coated with conductive adhesive, the conductive adhesive might peel off. In order to avoid this, it is required to improve the component manufacturing accuracy and to assemble components so as to ensure that the components are in adequate relative positions. However, both requirements cause increase in cost.

On the other hand, if the conductive adhesive coated on the connecting surface of the thin plate end portion should peel off, the contact area would decrease and thus the resistance in the contact surface might become larger. If the resistance in the contact surface is larger, the motor will generate more heat.

Particularly, driving motors for hybrid vehicles are required to provide higher power output and higher density than conventional motors. If a high voltage current flows through a high-density motor stator, the motor would generate more heat, posing a problem with the durability of the motor or the like.

In the technique described in JP2001-178053A, each laminated coil piece 120 is formed by integrally molding two sets of linear laminated conductors with an insulating resin. Molding components integrally in this way is an additional molding step, posing a problem of cost rise.

The present invention has been made in view of the above circumstances and has an object to provide a motor stator allowing assembly with high efficiency and at low cost and a manufacturing method for the motor stator.

### Means for Solving the Problems

To achieve the above object, the present invention provides the following configurations.
(1) A stator for motor, comprises: a stator core formed with a plurality of slots in an inner periphery thereof; a plurality of laminated conductors each including a plurality of thin plates, each laminated conductor being inserted in each slot; and an end connecting conductor including a plurality of laminated connecting thin plates each having a connecting portion for connecting an end portion of one of the laminated conductors to an end portion of another laminated conductor; wherein the end portion of each thin plate and the connecting portion of each connecting thin plate are tapered in thickness.
(2) In the stator for motor (1), the end portion of each thin plate and the connecting portion of each connecting thin plate are tapered in thickness to have slanted surfaces on one sides, the end portion of each thin plate and the connecting portion of each connecting thin plate are provided with an insulating layer on a non-slanted surface, and an adhesive is applied in a layer on at least one of the slanted surface of the connecting portion of the connecting thin plate of the connecting conductor and the slanted surface of the end portion of the thin plate of each laminated conductor.
(3) A stator for motor, comprises: a stator core formed with a plurality of slots in an inner periphery thereof; a first laminated conductor and a second laminated conductor, each of which includes a plurality of laminated thin plates, inserted in the same slot; wherein the first and second laminated conductors are encased in an insulating case while an insulating plate is interposed between the first and second laminated conductors.

According to another aspect, the present invention provides the following configurations.
(4) A method of manufacturing a stator for motor comprises: a stator core formed with a plurality of slots in an inner periphery thereof a plurality of laminated conductors each having a plurality of thin plates, each laminated conductor being inserted in each slot; and an end connecting conductor including a plurality of laminated connecting thin plates each having a connecting portion for connecting an end portion of one of the laminated conductors to an end portion of another laminated conductor; wherein the end portion of each thin plate and the connecting portion of each connecting thin plate are tapered in thickness, the plurality of thin plates have different thickness from each other, the plurality of connecting thin plates has the same thickness, and the manufacturing method comprises a step of adjusting positions of the connecting thin plates to between the thin plates of one of the laminated conductor and between the thin plates of another laminated conductor to be connected to the former one by use of a guide, and assembling the end connecting conductor to the laminated conductors.

The functions and advantages of the motor stator configured as above are explained below.

According to the configuration (1), the end portion of each thin plate and the connecting portion of each connecting thin plate are both tapered in thickness. Accordingly, in the process of assembling the end connecting conductor including the plurality of laminated connecting thin plates to the laminated conductors each including the plurality of thin plates inserted in different slots to connect the end portions of the different laminated conductors, the slanted surfaces of the tapered portions are unlikely to contact with each other up to a final stage of assembly. Thus, an adhesive layer or others on each tapered portion is unlikely to peel off.

According to the configuration (2), the end portion of each thin plate and the connecting portion of each connecting thin plate are tapered in thickness to have slanted surfaces on one sides, and the end portion of each thin plate and the connecting portion of each connecting thin plate are provided with an insulating layer on a non-slanted surface, and an adhesive is applied in a layer on at least the slanted surface of the connecting portion of the connecting thin plate. Accordingly, the area of the slanted surface can be larger to allow the adhesive to be applied wider, leading to a reduction in the contact resistance at joints between the conductors. Further, the insulating layer is formed on the non-slanted surface, so that insulation between the thin plates of each laminated conductor can be easily ensured.

In particular, the end portion of each thin plate and the connecting portion of each connecting thin plates are wholly tapered in thickness to have a slanted surface. This makes it possible to reduce the range where the slanted surfaces contact with each other.

According to the configuration (3), the stator for motor comprises the stator core formed with the plurality of slots in an inner periphery thereof and the first and second laminated conductors, each of which includes the plurality of laminated thin plates, inserted in the same slot. The first and second laminated conductors are encased in the insulating case while the insulating plate is interposed between the first and second laminated conductors. Accordingly, the first and second laminated conductors can be integrally combined by a simple assembling work without needing a molding process, while insulation is ensured therebetween.

The functions and advantages of the method of manufacturing the stator for motor, described in (4) are explained below.

Both end portions of each thin plate of the laminated conductor and both connecting portions of each connecting plate of the end connecting conductor are tapered in thickness. The plurality of thin plates is gradually different in thickness from one thin plate placed at one end in the direction of lamination to another thin plate placed at the other end.

On the other hand, the plurality of connecting thin plates has the same thickness, and thus it is difficult to assemble the end connecting conductor to the laminated conductor as compared with the case where the connecting thin plates have the same thickness.

Further, if the plurality of thin plates is different in width from one another, the thin plates can have the same cross-sectional area.

According to the present invention, in assembling the end connecting conductor to the different laminated conductors, the guide is used to adjust the positions of the connecting thin plates to between the thin plates of the different laminated conductors. Accordingly, the slanted surfaces of the tapered portions are unlikely to contact with each other up to a final stage of assembly. Thus, an adhesive layer or others on each tapered portion is unlikely to peel off.

### BRIEF DESCRIPTION OF THE DRAWINGS

FIG. 1 is a perspective view showing the shapes of a first laminated conductor, a second laminated conductor, and an end connecting conductor;

FIG. 2 is perspective view of a stator core in which the first and second laminated conductors are fitted;

FIG. 3 is a perspective view of an assembly of FIG. 2 to which the end connecting conductor is assembled;

FIG. 4 is a perspective view of an assembly of FIG. 3 to which a connecting terminal, U-,V-,W-phases terminals, and a neutral terminal are connected;

FIG. 5 is a perspective view of the first laminated conductor;

FIG. 6 is a perspective view showing a configuration that the first and second laminated conductors are placed interposing therebetween a plate-like insulating resin insulator;

FIG. 7 is a perspective view showing a configuration that the first and second laminated conductors interposing the insulating plate are covered with a insulating case;

FIG. 8 is a perspective view of the stator core;

FIG. 9A is a schematic front view showing a device for inserting connecting plates of the end connecting conductor into the first laminated conductor;

FIG. 9B is a schematic right side view showing the device for inserting the connecting plates of the end connecting conductor into the first laminated conductor;

FIG. 10 is a perspective view showing another example of the first and second laminated conductors;

FIG. 11 is a schematic diagram showing a first state in a process for assembling the end connecting conductor to the first and second laminated conductors;

FIG. 12 is a schematic diagram showing a second state in the process for assembling the end connecting conductor to the first and second laminated conductors;

FIG. 13 is a schematic diagram showing a third state in the process for assembling the end connecting conductor to the first and second laminated conductors;

FIG. 14 is a schematic diagram showing a fourth state in the process for assembling the end connecting conductor to the first and second laminated conductors;

FIG. 15 is a schematic diagram showing a fifth state in the process for assembling the end connecting conductor to the first and second laminated conductors;

FIG. 16 is a schematic diagram showing a sixth state in the process for assembling the end connecting conductor to the first and second laminated conductors;

FIG. 17 is a schematic diagram showing a seventh state in the process for assembling the end connecting conductor to the first and second laminated conductors;

FIG. 18 is a schematic diagram showing an eighth state in the process for assembling the end connecting conductor to the first and second laminated conductors;

FIG. 19 is a perspective view of a stator core assembled with a U-shaped laminated conductor in a second embodiment;

FIG. 20 is a perspective with of the assembly of FIG. 19 to which an end connecting conductor is connected; and

FIG. 21 is an exploded perspective view showing a configuration of a stator core in a prior art.

### BEST MODE FOR CARRYING OUT THE INVENTION

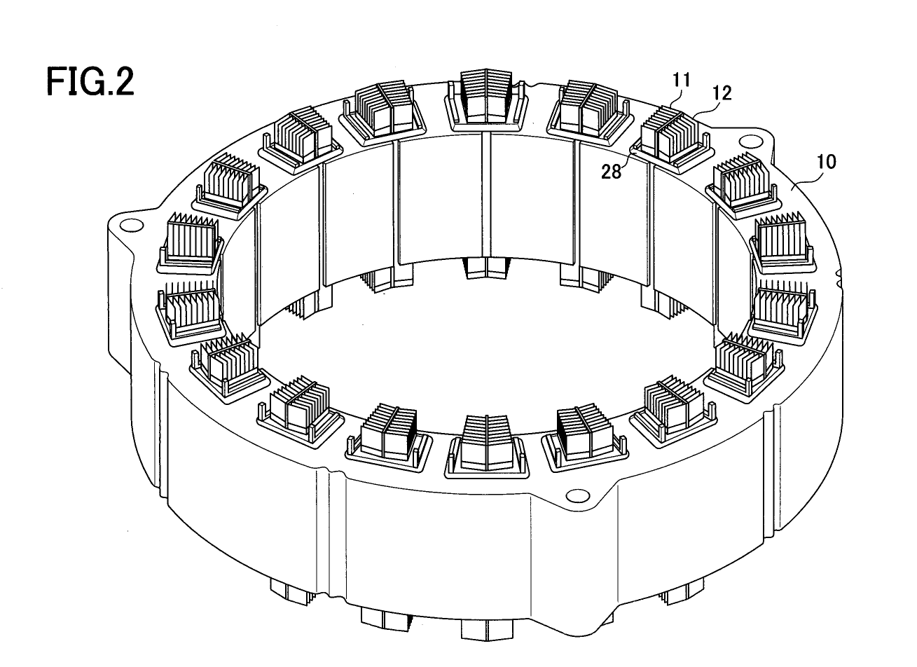

A motor stator of a first embodiment of the present invention will be described in detail referring to accompanying drawings. It is to be noted that the number of components and the size of each component in the following explanations are merely examples and may be changed appropriately. FIG. 2 is a perspective view of a stator core 10 in which a first laminated conductors 11 and a second laminated conductors 12 are fitted.

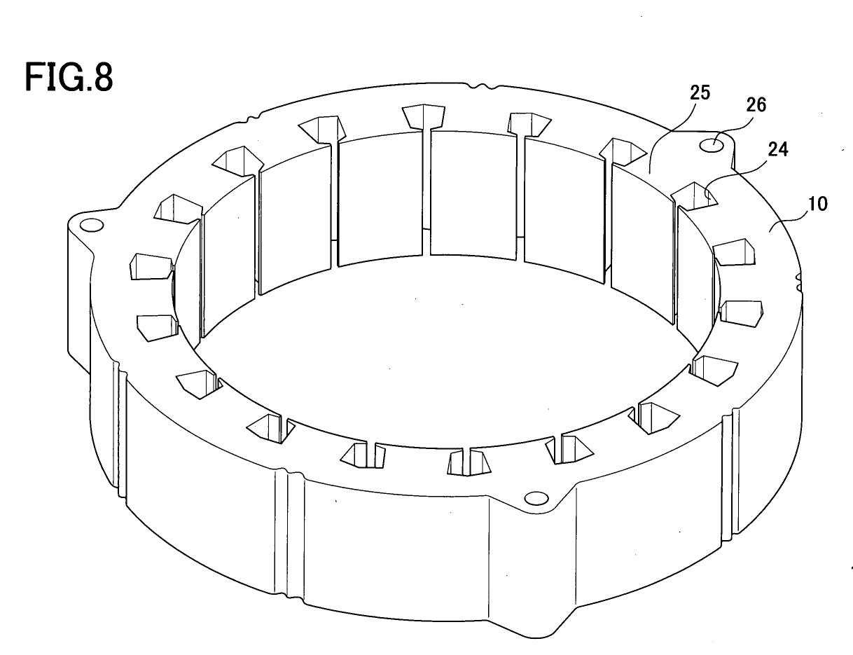

FIG. 8 is a perspective view of the stator core 10. The stator core 10 is a laminate of plural flat electromagnetic steel plates, taking the form of a hollow cylinder. Eighteen slots 24 and eighteen teeth portions 25 each formed between slots 24 are provided in an inner periphery of the stator core 10. The stator core 10 has three bolt holes 26.

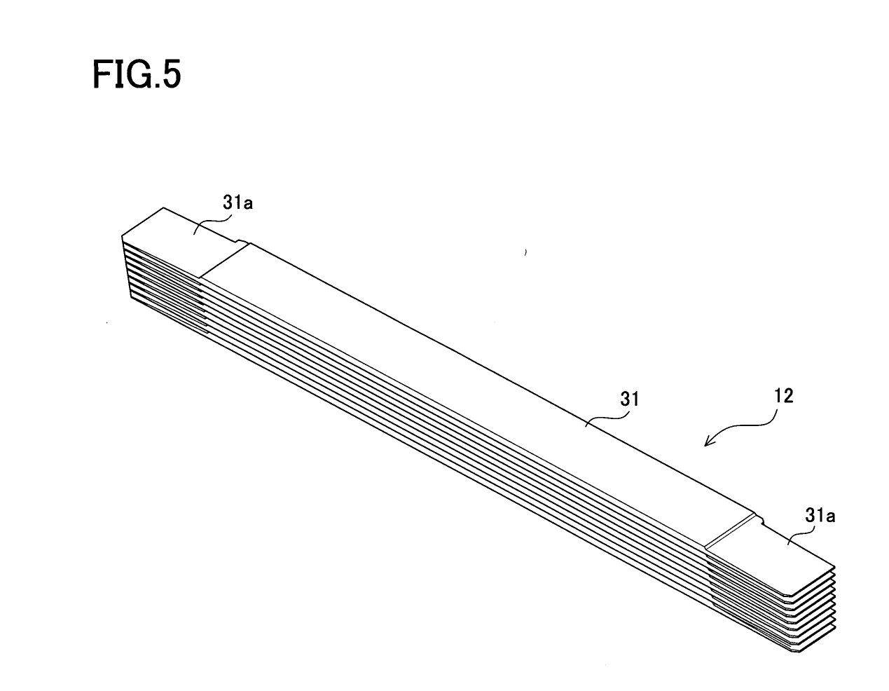

FIG. 5 shows a perspective view of a second laminated conductor 12 formed in such a way that nine thin plates 31 each having both end portions tapered in side view (in thickness) with slanted surfaces 31a whereby the thickness of each end portion becomes gradually smaller toward the outermost end. Each slanted surface 31a forms an angle of 6 degrees with respect to a flat surface of the end portion. The thin plates 31 are all copper plates with a thickness of 0.5 mm. Each thin plate 31 includes an insulating layer 31b on the surface where the slanted surface 31a is not formed. The process of forming the insulating layer 31b is explained below. Thermosetting adhesive is applied to one side of insulating tape made of polyimide or amidoimide. A heat roller is then made to run over it with the adhesive-coated surface stuck to the thin plate 31 to let the thermosetting adhesive set, so that the insulating tape serving as the insulating layer 31b is attached to one surface of the thin plate 31. The first laminated conductor 11 is structurally the same as the second laminated conductor and a detailed description thereof is omitted here.

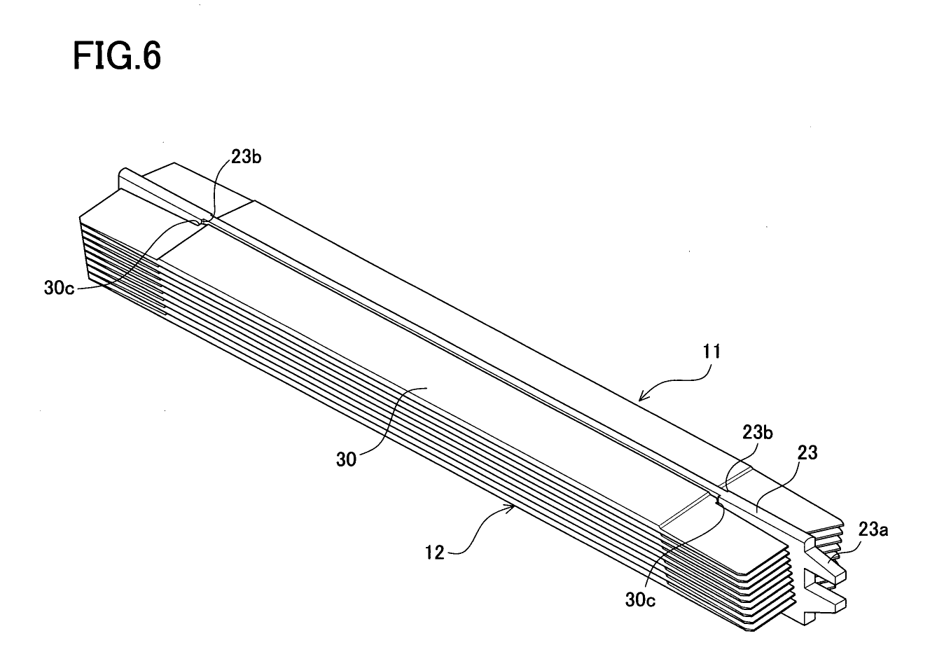

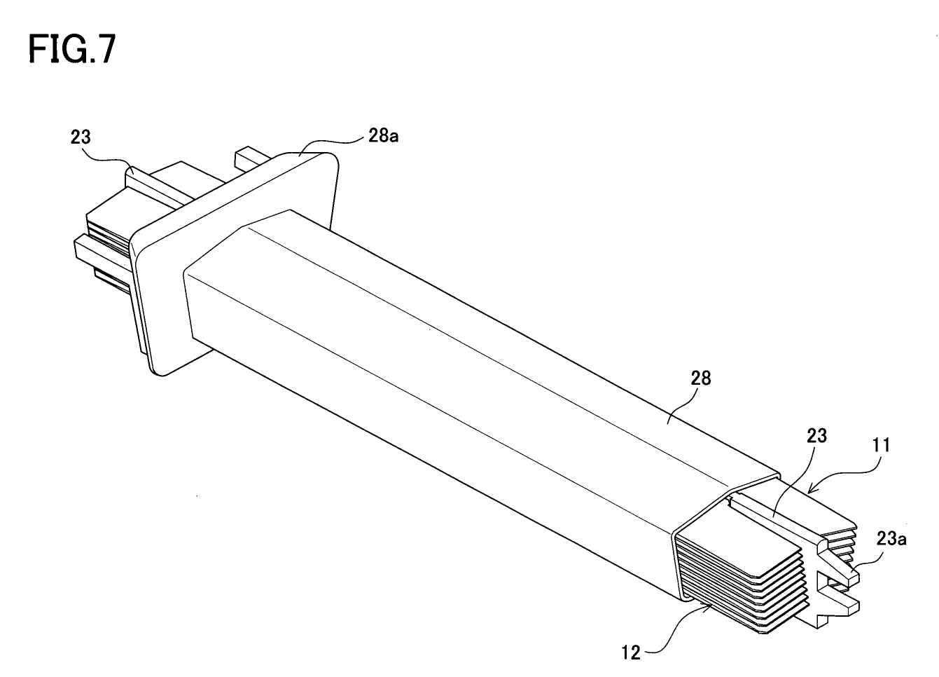

As shown in FIG. 6, the first laminated conductor 11 and the second laminated conductor 12 are arranged with am insulating plate 23 made of resin (insulating material) interposed therebetween. They are encased in an insulating case made of resin (insulating material) as shown in FIG. 7. As shown in FIG. 6, the insulating plate 23 has a thin middle portion and thicker end stepped portions 23b at both ends. A notch 30c is formed in the side of the end portion of the thin plate 30. By engaging this notch 30c with the stepped portion 23b of the insulating plate 23, the first laminated conductor 11 and the second laminated conductor 12 are longitudinally positioned in place. The insulating case 28 is formed with a flange 28a at one end.

A set of the first laminated conductor 11 and the second laminated conductor 12, encased in the insulating case 28 with the insulating plate 23 interposed therebetween as shown in FIG. 7, is inserted into each of the slots 24. At this time, the flange 28a comes into contact with an end face of the stator core 10 so that the insulating case 28 is positioned in place. On the other hand, the positions of the first laminated conductor 11, second laminated conductor 12, and insulating plate 23 are not determined relative to the insulating case 28. However, as shown in FIG. 2, the positions of the first laminated conductor 11 and second laminated conductor 12 are determined relative to an end face of the stator core 10 in the height direction by a jig (not shown). In other words, the height of the first laminated conductor 11 and second laminated conductor 12 from the end face of the stator core 10 is fixed.

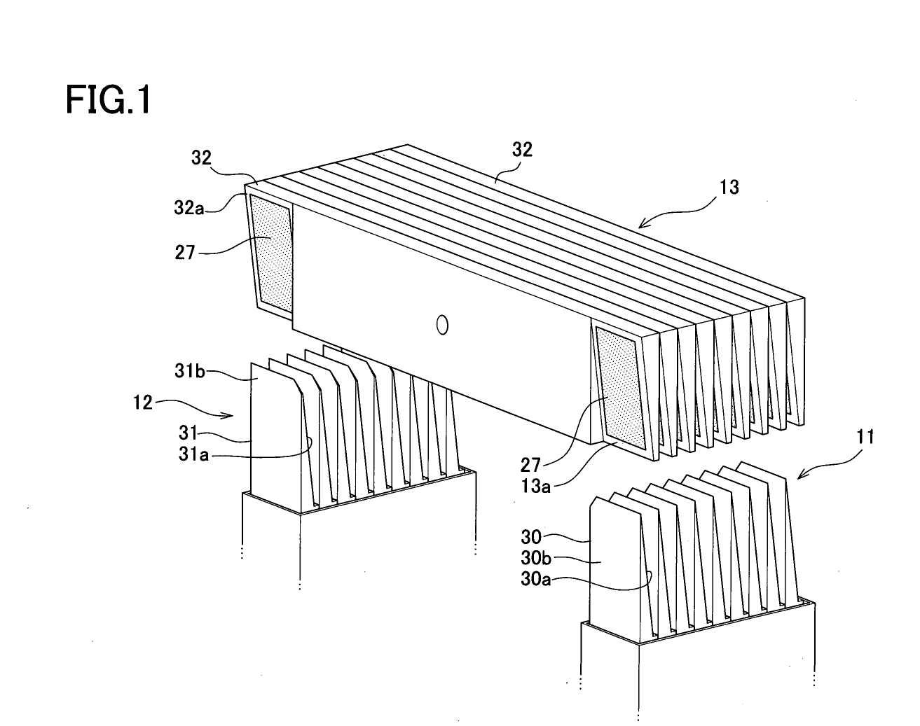

Next, referring to FIG. 1, how to connect thin plates 30 of the first laminated conductor 11 inserted in one slot 24 and thin plates 31 of one second laminated conductor 12 inserted in an adjacent 24 slot will be explained.

Firstly, an end connecting conductor 13 is comprised of nine connecting thin plates 32 which are laminated. Each connecting thin plate 32 has connecting portions 13a at both ends each being tapered downward in thickness to have a slanted surface 32a on one side. The inclination angle of the slanted surface 32a is 6 degrees relative to the vertical plane (the surface opposite the slanted surface 32a). In other words, the angle of the slanted surface 32a of the end connecting conductor 13 is different in direction from the angle of the slanted surface 30a of the thin plate 30 of the first laminated conductor 11 but the same in absolute value. An adhesive layer 27 is coated on each slanted surface 32a.

Next, how to form the adhesive layer 27 will be explained.

The adhesive layer 27 is formed by evenly applying particulate silver (in a gel state) dissolved in an organic solvent with a thickness of 10 μm by screen printing. More specifically, a gel silver solvent is applied with a mesh (mesh pitch: 200 μm) placed over a target area of the slanted surface 32a. At this time, a raised portion is formed around the target area by scribing in order to prevent the silver solvent from overflowing. Then, the silver solvent on the mesh is scraped off by a scraper. Then the mesh is removed. Consequently, a gel layer with a thickness of 10 μm is formed. The solvent is then evaporated and dried by heating. After drying, a silver paste coating is left, which does not easily come off even if slightly touched or rubbed, but would come off if rubbed with a sharp edge. Such rubbing should be avoided as far as possible in order to ensure stability in product performance.

All the nine thin plates 32 constituting the end connecting conductor 13 have the same thickness t (0.5 mm in the present embodiment).

On the other hand, as shown in FIG. 1, when the thin plates 30 and thin plates 31, which constitute the first laminated conductor 11 and second laminated conductor 12 respectively, have the same thickness (T=0.5 mm) as that of the thin plate 32, the thin plates 30, 31 can be engaged directly with the thin plates 32 of the end connecting conductor 13 because the array pitch of the thin plates 30 and 31 is the same as the array pitch of the thin plates 32.

However, in order to increase the power output of the motor, it is necessary to improve the conductor space factor in a slot. For this reason, generally, thin plates 30 and thin plates 31 arranged in one slot 24 are gradually wider in width from the inner periphery side to the outer periphery side of the slot 24 (i.e., in a radially outward direction of the stator core 10) so as to match the shape of the slot 24 of which width is larger on its outer periphery side.

Simultaneously, as shown in FIG. 10, the innermost thin plates 30, 31 are different in thickness from the outermost thin plates 30, 31. More specifically, the thin plates 30, 31 are gradually smaller in thickness from the innermost one to the outermost one. Thus, the outermost thin plates 30, 31 are the thinnest. Since the thickness is different in the above manner, the sectional area of the innermost thin plates 30, 31 and that of the outermost thin plates 30, 31 are made equal in a direction perpendicular to the height direction.

In other words, the thickness of the innermost thin plates 30, 31 is larger than that of the outermost thin plates 30, 31. This means that the slanted surfaces 30a and 31a of the first laminated conductor 11 and second laminated conductor 12 are not arranged with a constant pitch.

In contrast, the connecting thin plates 32 of the end connecting conductor 13 are all arranged with a constant pitch. If an attempt is made to directly insert the thin plates 32 between the thin plates 30 or 31, tips of some plates of the first laminated conductor 11 and second laminated conductor 12 might scrape the adhesive layers 27 of the end connecting conductor 13 and peel the adhesive layers 27.

While the width of the thin plates 30, 31 are larger toward the outer periphery side of the slot 24, the slanted surfaces 32a of the thin plates 32 of the end connecting conductor 13 is designed to be fixed and also equal to the width of the outermost thin plates 30, 31.

There is substantially no difficulty in assembling the end connecting conductor 13 to the first laminated conductor 11 and second laminated conductor 12 as shown in FIG. 1 using the thin plates 30, 31 with the same thickness. Therefore, how to assemble the end connecting conductor 13 to the first laminated conductor 11 and second laminated conductor 12 as shown in FIG. 10 using the thin plates 30, 31 of different thicknesses will be described below.

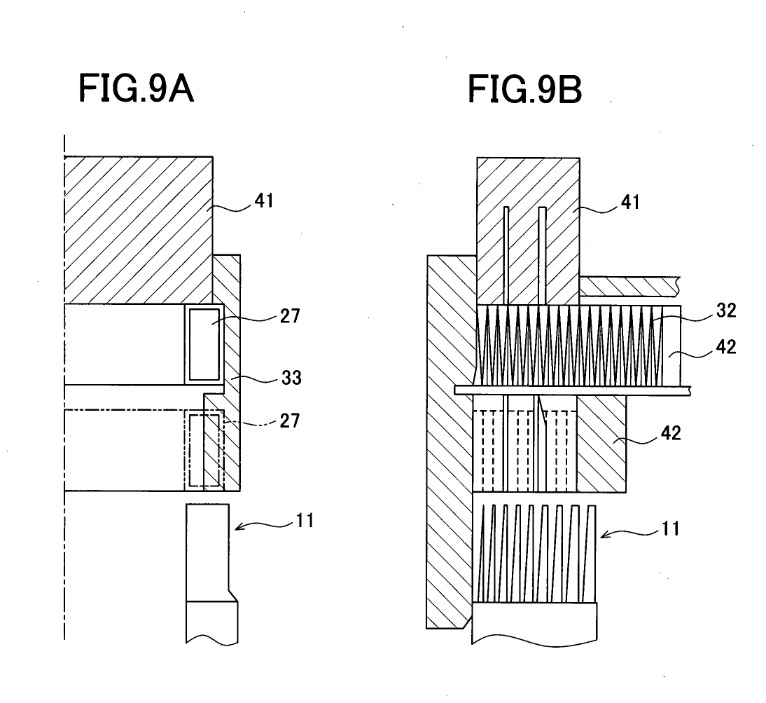

Specifically, to avoid a problem which tends to occur in such configuration, a guide member is used to determine the positions of the thin plates 32 of the end connecting conductor 13 relative to the thin plates 30 of the first laminated conductor 11 and the thin plates 31 of the second laminated conductor 12 so that the thin plates 32 are appropriately inserted between the thin plates 30 or 31. An inserting manner using the guide member will be explained referring to FIGS. 9A and 9B and FIGS. 11 to 18.

FIGS. 9A and 9B show a device for inserting the thin plates 32 of the end connecting conductor 13 into a first laminated conductor 11. FIG. 9A is a front view and FIG. 9B is a right side view. The device for inserting the thin plates 32 into a second laminated conductor 12 is symmetrical to that of FIGS. 9A and 9B, and therefore the device and the second laminated conductor 12 are not shown and their explanations are omitted.

Since the thin plates 32 of the end connecting conductor 13 all have the same thickness and shape, many ones can be housed in a cartridge 42 and to be supplied to a manufacturing line. The thin plates (nine plates in the present embodiment) 32 are separated by a shutter 41 and moved down. Just under them, the first laminated conductor 11 fitted in one slot 24 of the stator core 10 is located. A separator 43 provided with a guide member 33 including four guide pieces 33a, 33b, 33c, 33d is interposed between the end connecting conductor 13 and the first laminated conductor 1. The guide pieces 33a, 33b, 33c and 33d are made of super steel and polished and held in such a manner as to be easily deformable toward clearance so that even if a guide surface of each guide piece touches and rubs the adhesive layer 27, it does not affect the adhesive layer 27 seriously. The upper end of each guide piece 33a, 33b, 33c, 33d is rounded to prevent the upper end from scraping the adhesive layer 27.

Each guide piece 33a, 33b, 33c, 33d covers not the whole area of the adhesive layer 27 but almost half of the same in its width direction as shown in FIG. 9A. This is intended to minimize the possibility of the adhesive layer 27 being rubbed by the guide pieces 33a, 33b, 33c, 33d. Although each guide piece 33a, 33b, 33c, 33d covers almost half of the adhesive layer 27 in this embodiment, the guide pieces may be designed to have a smaller width to cover a smaller area of adhesive layer 27 in the width direction.

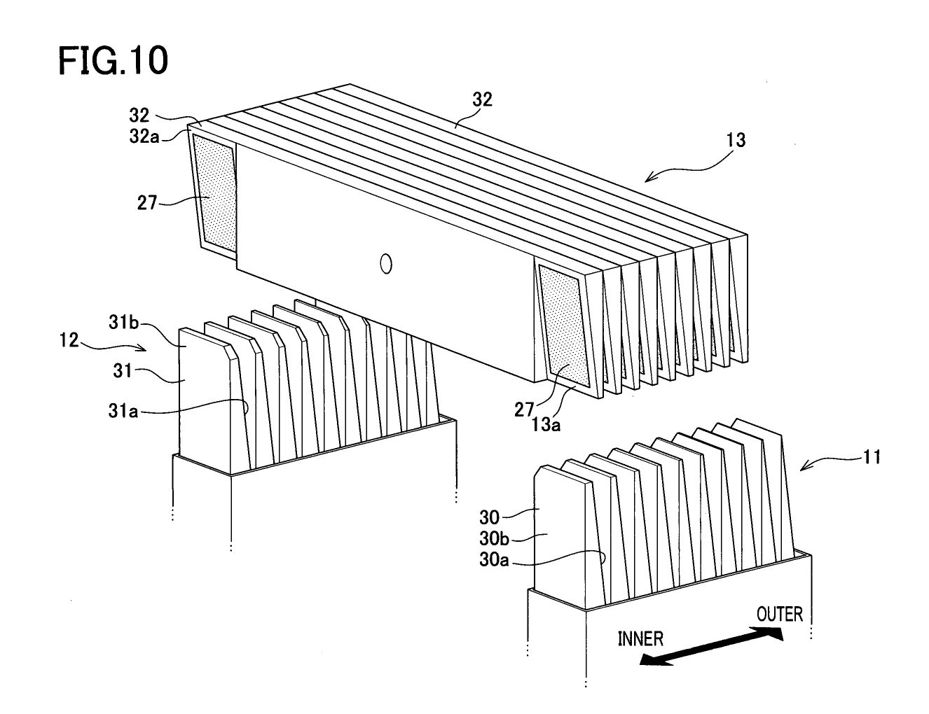

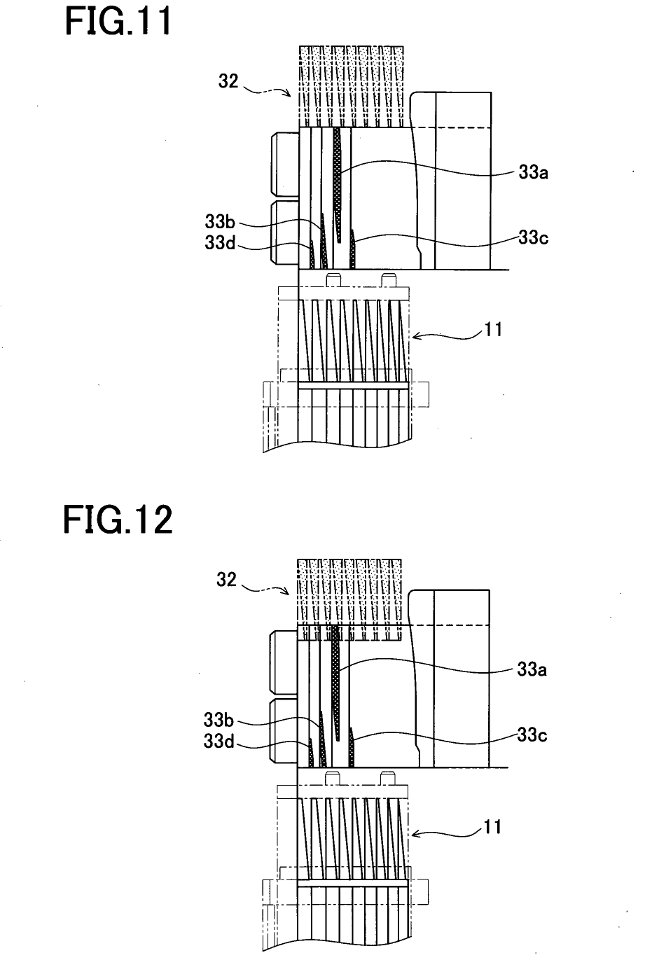

In FIG. 11, the right hand side of the first laminated conductor 11 corresponds to the outer periphery side of the stator core 10 and the left hand side corresponds to the inner periphery side. The figure shows that the thin plates 30 placed on the left side are thicker than those on the right side. When the end connecting conductor 13 is to be assembled to the first laminated conductor 11, it is less difficult to directly insert the thin plates 32 of the end connecting conductor 13 into the plates 30 if they are thinner. On the other hand, if the plates 30 are thicker, the tips of the plates 30 are likely to scrape the adhesive layers 27 of the thin plates 32 of the end connecting conductor 13. Hence, the guide member 33 is used mainly in guiding left-hand thin plates 30 of the first laminated conductor 11.

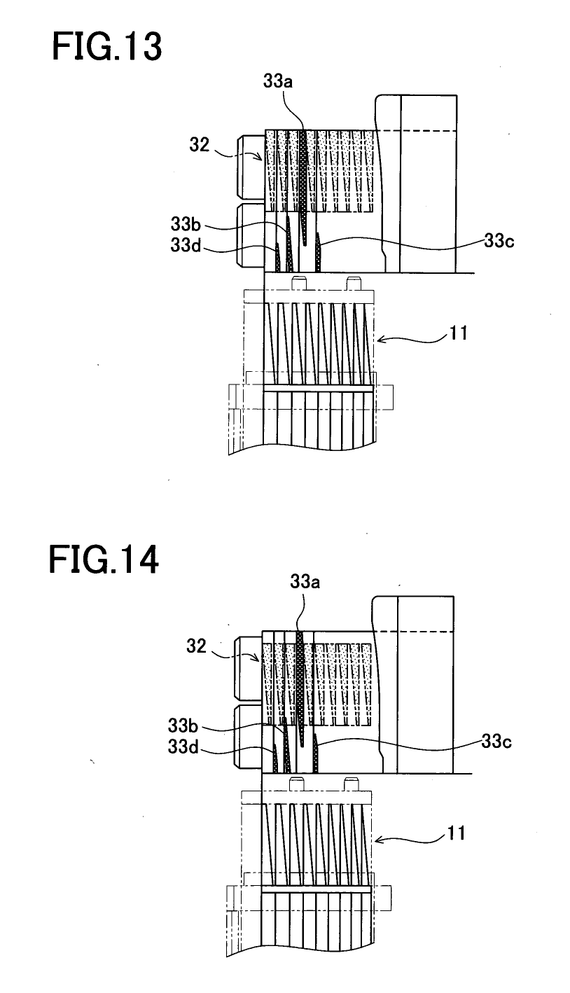

FIG. 12 shows that the shutter 41 is slightly down. The top end of the guide piece 33a located at the highest. position enters the space between the third and fourth ones of the nine connecting thin plates 32 from the left end. As the shutter 41 further goes down, the guide piece 33a fully enters the space between the third and fourth thin plates 32 from the left end. Accordingly, the thin plates 32 are completely divided into two groups, three on the left and six on the right, as shown in FIG. 13.

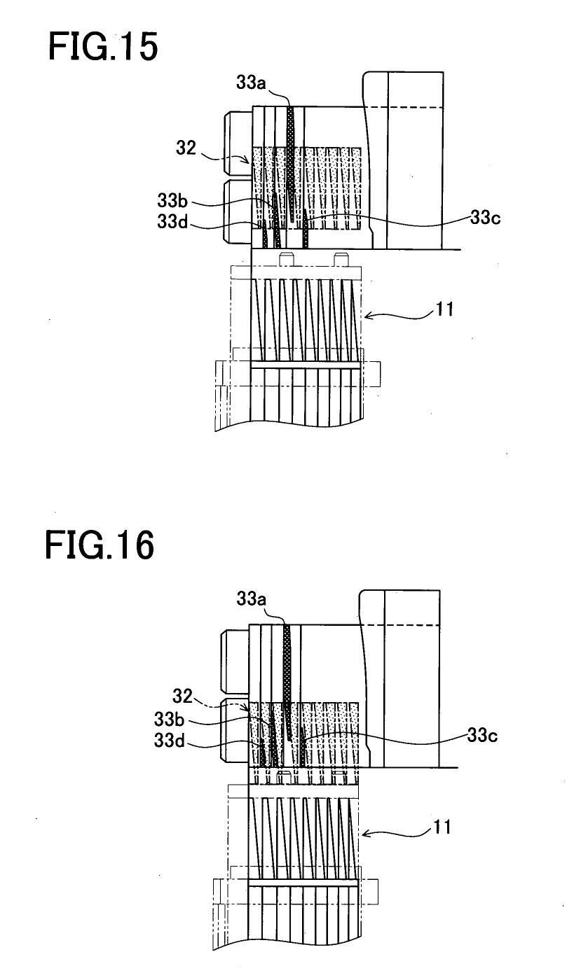

FIG. 15 shows that the shutter 41 has further moved down. The guide piece 33b whose upper end is at the second highest position enters the space between the second and third thin plates 32 from the left end. The guide piece 33c whose upper end is at the third highest position enters the space between the fourth and fifth thin plates 32 from the left end. The guide piece 33d whose upper end is at the lowest position enters the space between the first and second thin plates 32 from the left end.

As the shutter 41 is moved down further, the four guide pieces 33a, 33b, 33c, 33d increase the space between the first and second plates, the space between the second and third plates, the space between the third and fourth plates, and the space between the fourth and fifth plates as shown in FIG. 16, respectively. Accordingly, the thin plates 32 of the end connecting conductor 13 are positioned so that, even when the thin plates 32 are inserted between the thin plates 30 of the first laminated conductor 11, the tips of the thin plates 30 do not touch the adhesive layers 27 of the thin plates 32.

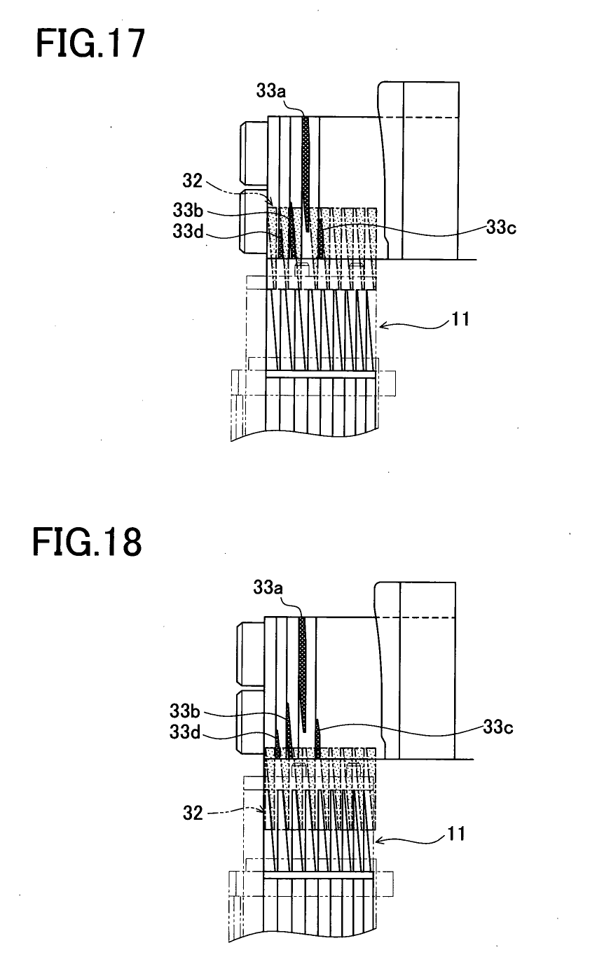

In this state, the nine connecting thin plates 32 are inserted between the nine thin plates 30 as shown in FIGS. 17 and 18. Thus, the tips of the thin plates 30 are unlikely to rub the adhesive layers 27 of the slanted surfaces 32a of the connecting thin plates 32, whereby the adhesive layers 27 are unlikely to be peel off.

After the end connecting conductor 13 is assembled to the first laminated conductor 11 in one slot 24 and the second laminated conductor 12 in an adjacent slot 24, the first laminated conductor 11 and the end connecting conductor 13 are heated together under pressure from both sides in the direction of a row of the thin plates 30 and the connecting thin plates 32 alternately arranged. This heats the silver paste of the adhesive layer 27 partially in a concentrated manner, making silver soldering of the laminated conductor 11 and the end connecting conductor 13. This silver soldering is similarly performed on the second laminated conductor 12 and the end connecting conductor 13.

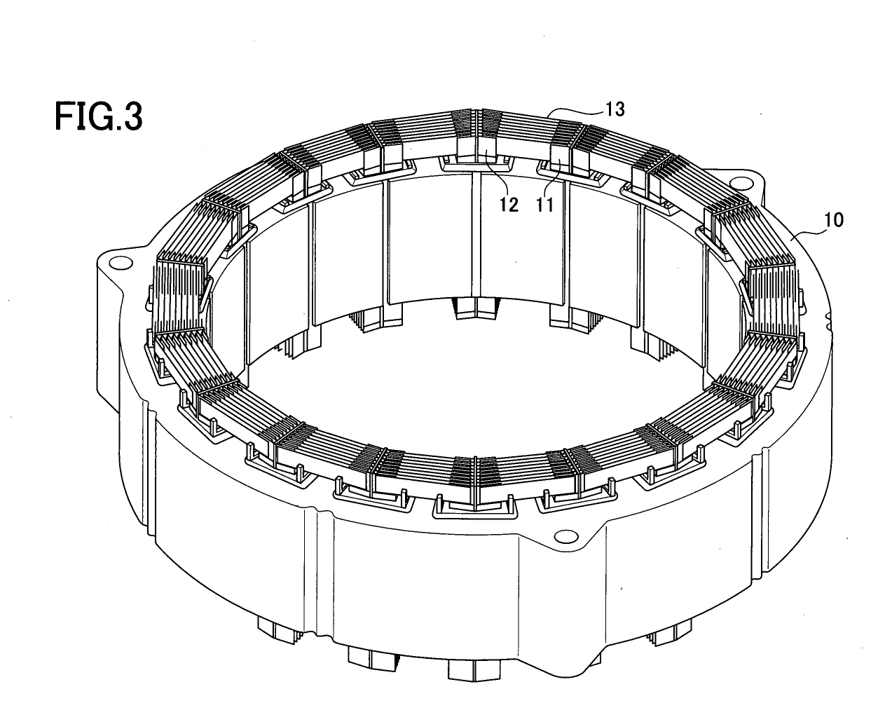

In the above way, all the end connecting conductors 13 to the corresponding laminated conductors 11 and 12. In the present embodiment, as shown in FIG. 3, on one end face (an upper face in the figure) of the stator core 10, eighteen end connecting conductors 13 are assembled and silver-soldered to the first laminated conductors 11 and second laminated conductors 12 inserted in eighteen slots 24.

Successively, the stator core 10 with the end connecting conductors 13 silver-soldered to the first laminated conductors 11 and second laminated conductors 12 is turned over, and end connecting conductors 13 are assembled and silver-soldered to the first laminated conductors 11 and second laminated conductors 12 on an opposite end face (a lower face in the figure) of the stator core 10. This process is almost the same as the abovementioned and hence only a difference will be described and the same points will not be repeated.

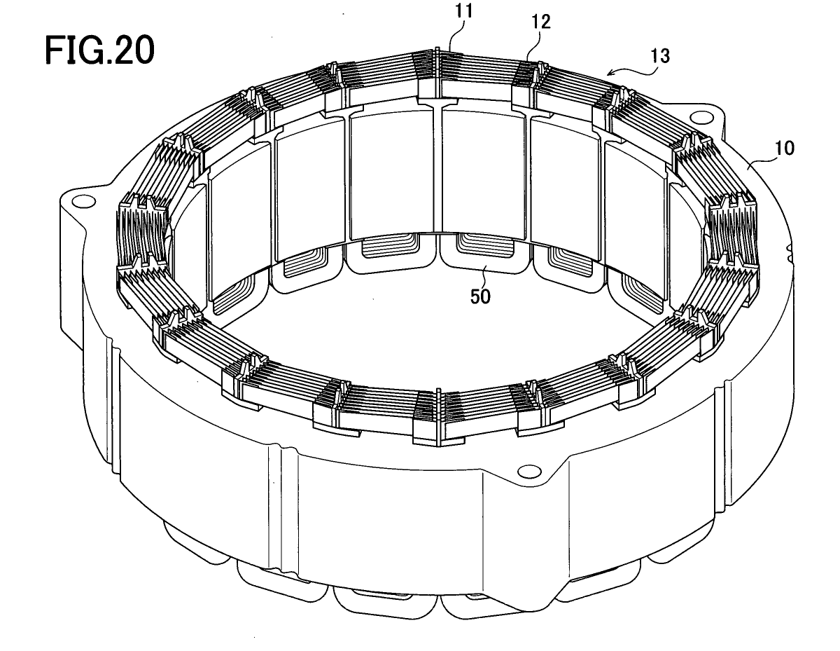

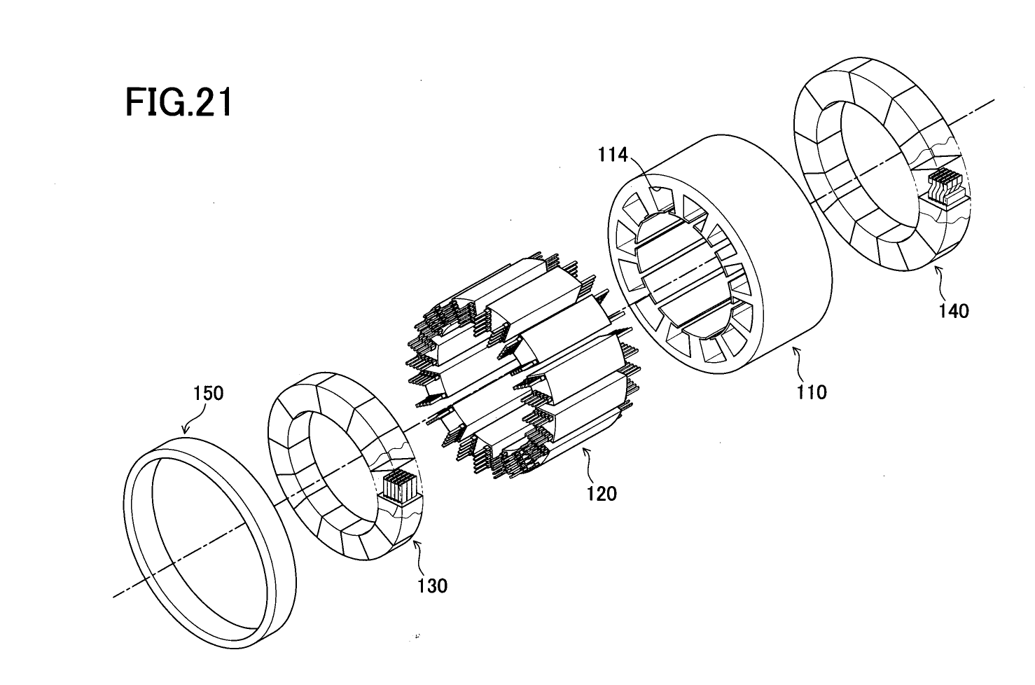

The difference is that the first thin plate 30 of the first laminated conductor 11 is connected with the second thin plate 31 of the second laminated conductor 12 as shown in FIG. 20. In this way, the n-th thin plate 30 of the first laminated conductor 11 and the (n+1)-th thin plate 31 of the second laminated conductor 12 are connected sequentially. Such connection between the first laminated conductor 11 in one slot 24 and the second laminated conductor 12 in an adjacent slot 24 makes a loop between the first thin plate 31 of the second laminated conductor 12 and the ninth thin plate 30 of the first laminated conductor 11. The ninth thin plate 30 of the first laminated conductor 11 and the first thin plate 31 of the second laminated conductor are unconnected.

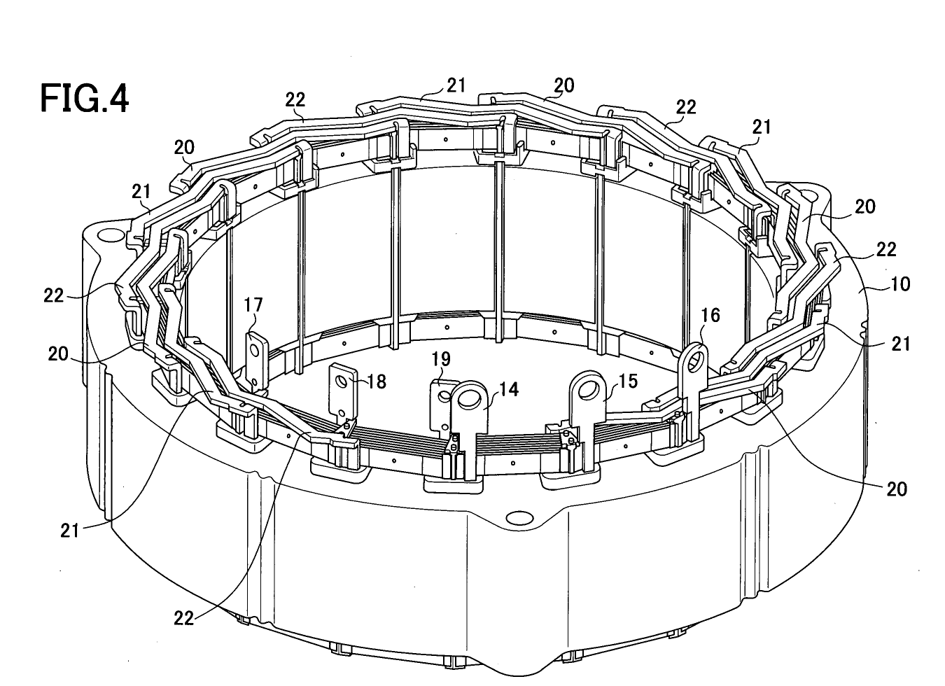

Next, connecting terminals 20, 21, and 22 (see FIG. 4) for constituting three phases U, V, and W respectively are connected sequentially. More specifically, the unconnected ninth thin plate 30 of the first laminated conductor 11 is connected with the first thin plate 31 of a second conductor 12 of the third phase next one (next but two) and such connections are made sequentially. Consequently, a U-phase coil, a V-phase coil and a W-phase coil are formed on the whole circumference of the stator core 10.

Then, a U-phase terminal 14 and a neutral line terminal 17 are connected to an end of the U-phase coil. A V-phase terminal 15 and a neutral line terminal 18 are connected to an end of the V-phase coil. A W-phase terminal 16 and a neutral line terminal 19 are connected to an end of the W-phase coil.

Next, though not shown, the stator core 10, end connecting conductors 13, first laminated conductors 11 and second laminated conductors 12 and so on are covered are covered by insert molding using a die while only the U, V and W phase terminals 14, 15, 16 and neutral line terminals 17, 18, 19 are left outside the die. A stator is thus completed.

As detailed above, the motor stator in the present embodiment includes: the stator core 10 with the plurality of slots 24 in an inner periphery, the first laminated conductors 11 each having the plurality of laminated thin plates 30 to be inserted into each slot 24, the second laminated conductors 12 each having the plurality of laminated thin plates 31 to be inserted into each slot 24, and the end connecting conductors 13 each having the plurality of laminated connecting thin plates 32 for connecting a first laminated conductor 11 in one slot 24 to a second laminated conductor 12 in another slot 24. The end portions of thin plates 30 and 31 and the connecting portions 13a of the thin plates 32 are tapered in thickness. Thus, when the adhesive layers 27 are coated on the slanted surfaces, the adhesive layers 27 are unlikely to be damaged in the process of assembling the end connecting conductor 13 to the first and second laminated conductors 11 and 12 without causing an increase in the resistance at joints, leading to less heat generation.

In addition, the end portion of each thin plate 30, 31 and the connecting portion of each thin plate 32 are formed with the slanted surfaces 30a, 31a and 32a on one side respectively. Further, the insulating layers 30b, 31b are formed on the non-slanted surfaces of the thin plates 30, 31, opposite to the slanted surfaces 30a, 31a. The adhesive layers 27 are formed on the slanted surfaces 32a of the connecting portions 13a of the thin plates 32. Accordingly, the area of a slanted surface can be larger to allow adhesive to be coated wider, leading to a reduction in the contact resistance at joints between conductors. Besides, since the insulating layers are formed on non-slanted surfaces, insulation between the thin plate conductors can be easily assured.

Furthermore, since the connecting surface is wholly slanted, the following advantage can be obtained. Even if only the end portions of the connecting surfaces of the thin plates are slanted, it is possible to prevent the adhesive layers from being scraped off by an end portion edge. However, when the connecting surfaces are wholly slanted as above, the range of rubbing by contact between the slanted surfaces can be reduced. Also, if only the end portions should be slanted, a space with no mutual contact would be generated there; however, since more current flows in the shortest distance area as a current flows from a laminated conductor to a connecting conductor, if there should be a space around the root of the joint of the laminated conductor, the problem of increased contact resistance would arise. This problem can be avoided by the connecting surfaces in the present embodiment which are wholly slanted.

Furthermore, the motor stator of the present embodiment includes the stator core 10 with the slots 24 in an inner periphery, and a set of the first and second laminated conductors 11 and 12 inserted in the same slot 24, each conductor having plural laminated thin plates 30 or 31. The first laminated conductor 11 and the second laminated conductor 12, with the insulating plate 23 interposed therebetween, are encased in the insulating case 28. Therefore, the first and second laminated conductors 11 and 12 are united only by simple assembling work while assuring insulation without any molding process.

According to the manufacturing method of the present embodiment for a motor stator which includes the stator core 10 with the slots 24 in an inner periphery, the first and second laminated conductors 11 and 12, each having the plurality of laminated thin plates 30 or 31, and the end connecting conductor 13 having the plurality of laminated connecting thin plates 32 for connecting the end portions of the first laminated conductor 11 in one slot 24 and the end portions of the second laminated conductor 12 in another slot 24, the end portions of thin plates 30, 31 and the connecting portions 13a of connecting thin plates 32 are all tapered; the plural thin plates 30, 31 are gradually different in thickness and the connecting thin plates 32 are the same in thickness; and, in assembling the end connecting conductor 13 to the first laminated conductor 11 and the second laminated conductor 12, the guide pieces 33a, 33b, 33c, 33d are used to adjust the positions of the connecting thin plates to the positions between the thin plates of the laminated conductors so that no contact between slanted portions occurs before the final stage of assembly in which slanted surfaces contact each other, and thus adhesive layers 27 coated on the slanted surfaces are unlikely to peel off.

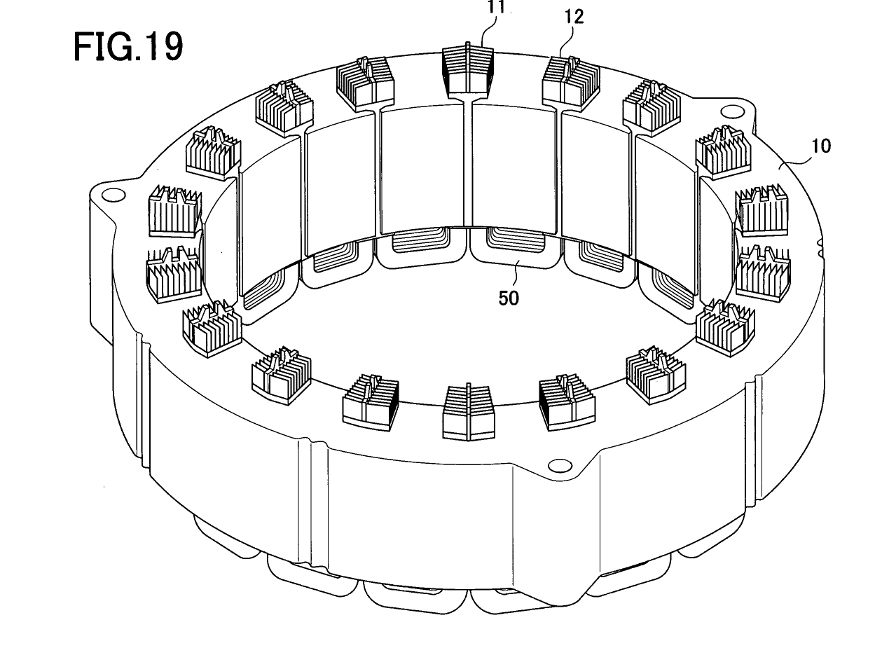

A second embodiment of the present invention will be described referring to FIGS. 19 and 20. The lower end portions of a first laminated conductor 11 and a second laminated conductor 12 are connected with a U-shaped laminated conductor 50. This is equivalent to the first embodiment in which the end portions of the first laminated conductor 11 and the second laminated conductor 12 are connected by the end connecting conductor 13 on only one side of the stator core 10.

As shown in FIG. 20, neighboring U-shaped laminated conductors 50 are connected by a connecting conductor 13. The end portions of thin plates constituting each U-shaped laminated conductor 50 have the same slanted surfaces as the end portions of the first laminated conductor 11 and the second laminated conductor 12. The end connecting conductor 13 is the same as that in the foregoing embodiment.

The assembling process in the present embodiment is performed in the same manner as the connecting process after the step of turning over the stator core 10 in the first embodiment. More specifically, by connecting the n-th thin plate 30 of the first laminated conductor 11 in one slot 24 and the (n+1)-th thin plate of the second laminated conductor 12 in an adjacent slot 24 sequentially, the first laminated conductor 11 and second laminated conductor 12 make a loop between the first thin plate 31 of the second laminated conductor 12 and the ninth thin plate 30 of the first laminated conductor 11. A detailed description is omitted here.

According to this embodiment, only one end portions (upper end portions in the figure) are connected using the connecting conductors 13, so that production efficiency can be improved.

The present invention is not limited to the foregoing embodiments and may also be embodied by partially modifying the configuration without departing from the scope of the invention.

For instance, the adhesive layer 27 is formed on the slanted surface 32a of the connecting thin plate 32 in the above embodiments. As an alternative, it may be formed on the slanted surfaces 30a and 31a of thin plates 30 and 31 or it also may be formed on the slanted surfaces of both the connecting thin plate 32 and the thin plates 30, 31.

Further, although silver paste is used as an adhesive in the above embodiment, another type of soldering paste may be used instead.

1. A stator for motor, comprising:
a stator core formed with a plurality of slots in an inner periphery thereof;
a plurality of laminated conductors each including a plurality of thin plates, each laminated conductor being inserted in each slot; and
an end connecting conductor including a plurality of laminated connecting thin plates each having a connecting portion for connecting an end portion of one of the laminated conductors to an end portion of another laminated conductor;
wherein the end portion of each thin plate and the connecting portion of each connecting thin plate are tapered in thickness.

2. The stator for motor according to claim 1, wherein
the plurality of thin plates has the same thickness, and
the plurality of connecting thin plates has the same thickness.

3. The stator for motor according to claim 1, wherein
the plurality of thin plates are gradually different in thickness from one thin plate at one end in a direction of lamination to another thin plate at the other end, and
the plurality of connecting thin plates has the same thickness.

4. The stator for motor according to claim 1, wherein
the end portion of each thin plate and the connecting portion of each connecting thin plate are tapered in thickness to have slanted surfaces on one sides,
the end portion of each thin plate and the connecting portion of each connecting thin plate are provided with an insulating layer on a non-slanted surface, and
an adhesive is applied in a layer on at least one of the slanted surface of the connecting portion of the connecting thin plate of the connecting conductor and the slanted surface of the end portion of the thin plate of each laminated conductor.

5. The stator for motor according to claim 4, wherein
the adhesive layer is a silver paste coating.

6. The stator for motor according to claim 5, wherein
a raised portion is formed around the silver paste coating.

7. A stator for motor, comprising:
a stator core formed with a plurality of slots in an inner periphery thereof;
a first laminated conductor and a second laminated conductor, each of which includes a plurality of laminated thin plates, inserted in the same slot;
wherein the first and second laminated conductors are encased in an insulating case while an insulating plate is interposed between the first and second laminated conductors.

8. A method of manufacturing a stator for motor comprising:
a stator core formed with a plurality of slots in an inner periphery thereof;
a plurality of laminated conductors each having a plurality of thin plates, each laminated conductor being inserted in each slot; and
an end connecting conductor including a plurality of laminated connecting thin plates each having a connecting portion for connecting an end portion of one of the laminated conductors to an end portion of another laminated conductor;
wherein the end portion of each thin plate and the connecting portion of each connecting thin plate are tapered in thickness,
the plurality of thin plates is gradually different in thickness from one thin plate at one end in a direction of lamination to another thin plate at the other end,
the plurality of connecting thin plates has the same thickness, and
the manufacturing method comprises a step of adjusting positions of the connecting thin plates to between the thin plates of one of the laminated conductor and between the thin plates of another laminated conductor to be connected to the former one by use of a guide, and assembling the end connecting conductor to the laminated conductors.
